(19) United States
(12) Patent Application Publication
(10) Pub. No.: US 2023/0092511 A1
(43) Pub. Date: Mar. 23, 2023

(54) LOGISTICS SYSTEM, FLEET MANAGEMENT SERVER AND METHOD FOR OPERATING A LOGISTICS SYSTEM

(71) Applicant: Jungheinrich AG, Hamburg (DE)

(72) Inventors: Alexander Heiko WEBER, Hamburg (DE); Sebastian LINDEMANN, Hamburg (DE); Dominik OFF, Hamburg (DE)

(21) Appl. No.: 17/945,236

(22) Filed: Sep. 15, 2022

(30) Foreign Application Priority Data
Sep. 17, 2021 (DE) 10 2021 124 159.6

(51) Int. Cl. G06Q 10/08; G06Q 10/06

(52) U.S. Cl. CPC G06Q 10/08; G06Q 10/06315

(57) ABSTRACT

A logistics system (2), a fleet management server (12), and a method for operating a logistics system. The logistics system includes an external server (4) and at least one logistics center (6). The logistics center includes a plurality of logistics handling devices (9) which are present and operable at a logistics site; a fleet management server (12); and a plurality of access points (14). The fleet management server is configured to operate, via the access points, a wireless data connection (16) with the logistics handling devices of the logistics center, and to provide a programming interface. The fleet management server and the external server are configured to operate a data connection via the programming interface using a network protocol. Via the data connection, data are transmitted relating to at least one logistics handling device of the plurality of logistics handling devices that can be operated in the logistics center.

### FIELD OF INVENTION

The invention relates to a logistics system comprising an external server and at least one logistics center, wherein the logistics center comprises a plurality of logistics handling devices present at a logistics site and which can be operated at the logistics site, and wherein both an industrial truck and a logistics device which interacts with the industrial truck are referred to as a logistics handling device. Furthermore, the logistics center comprises a fleet management server and a plurality of access points, wherein the fleet management server is configured to operate, via the access points, a wireless data connection to the logistics handling devices of the logistics center.

Furthermore, the invention relates to a fleet management server in such a logistics system. The invention also relates to a method for operating a logistics system, wherein the logistics center comprises an external server and at least one logistics center, wherein the logistics center comprises: a plurality of logistics handling devices which are present at a logistics site and are operated at the logistics site, wherein both an industrial truck and a logistics device which interacts with the industrial truck are referred to as a logistics handling device; a fleet management server; and a plurality of access points, wherein the fleet management server operates, via the access points, a wireless data connection to the logistics handling devices of the logistics center.

### BRIEF DESCRIPTION OF RELATED ART

In a logistics site, the logistics handling device used there, e.g., industrial trucks, in many cases communicate with a fleet management server via wireless data connections. This and further network components that are required to establish the data connection form a site communications system. Operating data of each individual industrial truck, e.g., its number of operating hours or its charge state, can be requested via the fleet management server. In some sites, the fleet management server can also access the vehicle control system of the industrial trucks and request information from this. For example, an error memory of the vehicle control system can be read.

From U.S. Pat. No. 8,583,314 B2, a system is known that provides an overview on a screen (dashboard) so that status information of the industrial trucks present at a site can be retrieved at different and more or less detailed levels. It is also possible to communicate data of the industrial trucks to a trusted server of a third party. It is thus possible to collect and evaluate the wirelessly collected information from the industrial trucks across different sites.

When exporting data, it is usual to perform a manual request or a manual export of the fleet management data—for example, via an internet front end. The data exchange takes place by exchanging files, i.e., individual files, which contain the corresponding information for operating or using the industrial trucks, are retrieved, e.g., from the fleet management server, or exported manually therefrom. Such a data exchange is relatively cumbersome for the user and in addition can only be carried out very slowly.

### BRIEF SUMMARY OF THE INVENTION

It is an aim of the invention to provide a logistics system, a fleet management server in a logistics system, and also a method for operating a logistics system, wherein this logistics system comprises an external server and a logistics center, which in turn comprises at least one logistics site where a plurality of logistics handling devices can be operated, and wherein a data exchange between the external server and the logistics center is to be improved.

The aim is achieved by a logistics system comprising an external server and at least one logistics center, wherein the logistics center comprises:
a plurality of logistics handling devices which are present at a logistics site and can be operated at the logistics site, wherein both an industrial truck and a logistics device that interacts with the industrial truck are referred to as a logistics handling device;
a fleet management server; and
a plurality of access points,
wherein the fleet management server is configured to operate, via the access points, a wireless data connection to the logistics handling devices of the logistics center,
   wherein this logistics system is further developed by the fleet management server being configured to provide a programming interface (API), and the fleet management server and the external server being configured to operate a data connection via the programming interface (API) using a network protocol, and, via this data connection, to transmit data relating to at least one logistics handling device of the plurality of logistics handling devices that can be operated in the logistics center.

The programming interface, hereafter referred to as “API,” derived from the widely used English designation, “application programming interface,” is operated, for example, on the basis of TCP/IP or primarily HTTP. By using an API, high-frequency communication can be provided between the external server and the fleet management server of the logistics center. Such high communication requirements have not as yet been imposed on logistics systems. It is possible via the API to implement on the basis of a protocol a fast and automatic data exchange, which hitherto has not been possible with conventional solutions.

The data connection between the external server and fleet management—in particular, the data connection between the external server, fleet management, and at least one logistics handling device—is in particular bidirectional. It is thus, for example, possible with the external server not only to retrieve and evaluate usage data of the logistics handling devices operated at a logistics site, e.g., a fleet of industrial trucks, but, if necessary, also to configure one or more industrial trucks of the fleet. The usage data of the industrial trucks are available to the external server at a high frequency, and thus virtually in real time. This enables a correspondingly rapid evaluation of the usage data.

As mentioned by way of example above, the data connection can be made to one or more industrial trucks. However, logistics devices which interact with the industrial truck are also designated as logistics handling devices. Accordingly, it is also provided that, alternatively or additionally, one or more data connections to one or more such logistics devices be operated. A logistics device is, for example, a charging device for an industrial truck or a storage and retrieval machine of a rack, present in the logistics site, with which the industrial truck interacts, i.e., for example, stores logistics units in this rack or retrieves them therefrom.

According to one embodiment, the logistics handling device is an industrial truck. For this reason, in the context of the present description, reference is made primarily to an industrial truck as a logistics handling device. However, the aspects explained relate in the same or similar manner to the other logistics handling devices which are not industrial trucks, i.e., for example, charging devices for industrial trucks.

In a logistics system according to aspects of the invention, it is possible, by means of the significantly better—because faster and automatable—data exchange, to provide an external server with a real-time image or near-real-time image of the usage situation of the industrial trucks in the logistics center. This creates enormous possibilities for optimizing the use of the industrial trucks in the logistics system.

The logistics center is not necessarily located at a single site. The logistics center can have multiple logistics sites which are located at different geographical locations. Furthermore, it is not necessary, for example, for the fleet management server to be present at the location of the logistics site itself. The fleet management server can be arranged to be spatially remote from the logistics site or even be implemented, for example, as a virtual machine in a decentralized cloud.

Access to the API provided by the fleet management server is organized via programming interface keys, hereafter referred to as “API keys.”

According to one embodiment, it is provided that the external server be set up to transmit an API key to the fleet management server and the fleet management server be set up to allow or deny access of the external server to the programming interface, depending upon an authorization of the API key.

Depending upon the authorization of the API key, the external server receives a read access, a write access, or a read-and-write access, for example. The access rights can also relate, for example, to specific resources of the fleet management server. These resources can, for example, be certain data sets or certain databases. For example, usage data of the industrial trucks are present in these data sets or databases. These data sets can also be assigned to different classes. The classes represent, for example, certain confidentiality levels or authorization levels. Depending upon the authorization of the API key, the external server is given access to all or to only certain classes of data, for example.

Another authorization level, which can be regulated via the API key, is access to one or more logistics sites that are covered by the logistics center. For example, the API key authorizes the external server to access only one logistics site or a defined group of logistics sites of the logistics center.

Access control regarding the logistics site is superordinate to access control to the resources of the fleet management server. This means that the external server cannot then access resources of the fleet management server unless it also has the corresponding authorization for the logistics site to which the corresponding fleet management server is assigned.

The API key can also authorize the external server to directly access logistics handling devices, e.g., industrial trucks or charging devices, of the logistics site. Even this access right is subordinate to the access right to the logistics site, which means that access to one or more resources of one or more logistics handling devices is only permitted when authorization is present for the logistics site at which the logistics handling devices can be operated. The resources of the logistics handling device are in particular endpoints, whose data are transmitted via parameters—specific to this end point—of the programming interface (API). End point can be not only data sources, but also data sinks.

The authorization of the API key can comprise, for example, read access, write access, or read-and-write access, which relates to certain resources of a logistics handling device. These resources can also be data sets or databases, but sensors whose data can be requested or read directly can likewise be regarded as resources. Here too, a classification of the resources can again be undertaken, which can be reflected in the authorization of the API key. For example, the authorization of the API key is configured such that it can access only resources of the logistics handling device of certain classes. The classes can, for example, be divisions corresponding to a confidentiality scale or operational safety scale. For example, an API key thus authorizes access to sensor data of the logistics handling device, e.g., the vehicle, but not to personal data. It is also conceivable for an API key to, for example, authorize the external server to access data sets of the logistics handling device, but not to allow the direct reading of sensors. A further classification can be made, for example, with regard to the importance of the relevant parameters for the operability of the logistics handling device.

According to a further advantageous embodiment, the logistics system is further developed in that the fleet management server is coupled by data technology to a plurality of end points that are data sources and is configured to transmit data of at least one end point to the external server via a parameter—specific to this end point—of the programming interface (API).

The data sources can be present, for example, in the fleet management server or also in one or more of the logistics handling devices present at the logistics site of the fleet management server. For example, a data source is a data storage site in the fleet management server, in which data relating to the operation of the logistics handling devices in the logistics site is stored. The data source can also be a data memory which is present in a logistics handling device. In such a data memory, for example, data relating to an operation of this special industrial truck or charging device can be present. However, a data source can also be distributed over several entities. For example, a data source may consist of multiple data storage areas located at different physical locations. One part of the data can thus be present in a data memory of the fleet management server, and another part of the data can be present in a data storage location of the logistics handling device. Such distributed data can also be data relating to the operation of one or more logistics handling devices.

An authorization control of access to the data sources takes place via an authorization assignment of the parameters assigned thereto of the API. This access control is also effected via an API key which authorizes the external server to access one or more parameters of the API and thus the data sources assigned to the parameters. Here too, a classification can be made, e.g., the parameters can be classified on the basis of confidentiality levels, operational safety levels, or the like.

According to a further advantageous embodiment, the logistics system is further developed by the fleet management server being further configured to allow the external server to add at least one further parameter to the programming interface (API).

By allowing the external server to add further parameters to the external server, an extremely flexible system can be provided. The authorization to add additional parameters to the API again takes place via the API key. The external server is enabled by this functionality of the API to configure the API according to its own needs. The logistics system is therefore extremely flexible.

According to a further advantageous embodiment, it is provided that the fleet management server be further configured to allow the external server to request data of at least one end point via the parameter—specific to this end point—of the programming interface (API), wherein the end point is located in particular within a logistics handling device—for example, within an industrial truck.

In other words, the external server is enabled to request data from an end point that is a data source. In a similar way as already explained above, this authorization takes place via the API key. For example, it is possible for the external server to retrieve data on its own initiative—for example, directly from an industrial truck or a charging device. These data are, advantageously, present in the external server virtually in real time. This is possible only by using an API. The external server is not dependent upon the fleet management server providing reports, e.g., at regular time intervals, about the operation of the logistics handling devices in the logistics site. The external server can then request the current data, for example, when it requires data evaluation.

The end point, which is located in particular within a logistics handling device such as an industrial truck, is, for example, a sensor or a data storage location within the logistics handling device—for example, the industrial truck.

According to further advantageous embodiments, the logistics system is further developed by the logistics handling device being an industrial truck and having at least one of the following features a) through e):

a) the industrial truck comprises a position sensor as an end point and is configured to determine its position within the logistics site,
b) the industrial truck comprises an acceleration sensor as an end point, wherein the industrial truck is in particular further configured to read the acceleration sensor several times over a period of time and to store read acceleration values in an internal data storage location, wherein the data storage location represents an end point,
c) the industrial truck is designed to determine a current operating hours value—in particular, to request this from a vehicle control system of the industrial truck—wherein the industrial truck comprises a data storage location for the operating hours value, and this data storage location is an end point,
d) the industrial truck comprises a traction battery and is designed to determine a current state of charge of the traction battery—in particular, to request this from a vehicle control system of the industrial truck—wherein the industrial truck comprises a data storage location for the state of charge, and this data storage location is an end point,
e) the industrial truck is designed to determine a current operating state—in particular, to request this from a vehicle control system of the industrial truck—wherein the industrial truck comprises a data storage location for the operating state, and this data storage location is an end point.

The current operating state of the industrial truck indicates, for example, whether the industrial truck is currently in operation or in a standby state, whether it is connected to a charging device for charging the traction battery or the like. According to further embodiments, in the data storage location of the industrial truck, for example, information is stored regarding: operating times of the industrial truck; operational statistics for operating modes such as driving/standing/stopping/stand-by; service reports of technicians who have carried out on-site maintenance or repair work on the industrial truck; information about a pre-operational inspection—for example, a visual inspection or a functional test.

The evaluation of the data of one or more of the aforementioned sensors or data storage locations makes it possible to draw precise conclusions about the operating situation of the industrial truck in the logistics site. On the basis of these data, usage of the industrial truck at the logistics site can be analyzed and optimized. Advantageously, this analysis and optimization can be carried out virtually in real time by using the API.

According to a further advantageous embodiment, the logistics system is further developed by the logistics handling device being configured to transmit data of at least one end point in the form of a push message to the external server via the parameter—specific to this end point—of the programming interface (API). The push message does not have to be generated directly by the logistics handling device. It is also provided that the logistics handling device, i.e., for example, the industrial truck, communicate with the fleet management server of the logistics center or logistics site and this generate the push message and communicate it via the API. According to a further advantageous embodiment, it is provided that the logistics handling device comprise at least one sensor—in particular, an acceleration sensor—as an end point and, by evaluating data captured by the sensor, be configured to detect a critical operating state, wherein the logistics handling device is further configured to send a push message to the external server when a critical operating state is detected.

One event which, for example, represents a critical operating state is a collision of an industrial truck with an object. Such a collision regularly results in high acceleration values and may call into question the operability or operational safety of the industrial truck. If such information is present on the external server almost in real time, a site manager of the logistics site, who has access to the external server, can initiate the corresponding measures for ensuring the operability and/or the operational safety of the site. Furthermore, the evaluation of critical operating states makes it possible, for example, to determine building-related weak points in routing or to obtain important information on routing for the planning of new logistics sites. The push message generated by the industrial truck, for example, can be passed on or forwarded only by the fleet management server. Again, it is determined on the basis of a previously transmitted API key whether the external server is authorized to receive the push messages.

According to a further advantageous embodiment, the logistics system is further developed by the fleet management server being coupled by data technology to a plurality of target points that represent data sinks and being configured to transmit data for at least one target point to the programming interface (API) via a parameter specific to this target point.

A data sink is, for example, a data storage location where the transmitted data—in particular, in the logistics handling device—are stored. Such a data storage location can, for example, access a display that is available in or on the logistics handling device, so that it is possible to transmit messages, warnings, or the like, virtually in real time to the logistics handling device—for example, the industrial truck.

The authorization of the external server to address such a target point again takes place via the API key. As already explained in the context of the end points, a classification can also be made for the target points—for example, on the basis of a confidentiality level or an operational safety level. The API key accordingly transmitted by the external server then receives an authorization to access one or more of these classes.

According to an advantageous embodiment, it is provided that the fleet management server be further configured to access a control system of the logistics handling device—in particular, a vehicle control system of the industrial truck—and to define parameters of the control system—in particular, of the vehicle control system—as target points, wherein, in particular, the fleet management server is configured to define as target points:
an employee authorization to operate the logistics handling device—in particular, the industrial truck,
a behavior pattern of the logistics handling device—in particular, of the industrial truck—further in particular relating to a driving behavior and/or
a behavior of a hydraulic system of the industrial truck,
a general operability of the logistics handling device—in particular, of the industrial truck.

According to further embodiments, the following can be defined as target points of the vehicle control system: a maximum lifting height of a mast of the industrial truck; a lifting/lowering speed of the load-handling attachments, e.g., a load fork; a maximum or general driving speed of the industrial truck; a general shutdown of the industrial truck.

Advantageously, such an access to parameters of the vehicle control system of the industrial truck allows it to be quickly configured or reconfigured. An interactive control or configuration of the industrial truck is also possible if the parameters are adjusted, for example, on the basis of data analysis. The data upon which the data analysis is based may, for example, have been previously retrieved from the industrial truck. Again, the authorization to perform a corresponding data transmission can be determined on the basis of authorization of the API key.

According to a further embodiment, parameters of the vehicle control system can be defined as target points, namely those parameters that relate to the detection of shock events on the industrial truck.

These parameters can be one or more, in particular three, shock thresholds that define shock values which, when reached or exceeded, result in a defined action. The shock thresholds may in particular relate to acceleration values that are measured by means of acceleration sensors on the industrial truck in a manner that is known per se. These acceleration values can be defined for the horizontal or vertical direction or for a combination of both. For example, a first shock threshold may be exceeded at an acceleration of 2 G in the horizontal direction or 1 G in the vertical direction. A second shock threshold may be exceeded at 2.5 G in the horizontal direction or 1.5 G in the vertical direction, and a third shock threshold may be exceeded at 3 G in the horizontal direction or 2 G in the vertical direction. When the above-mentioned and exemplary shock thresholds are exceeded, specific measures are implemented or carried out. For example, a display can be made on the industrial truck and/or a report on a shock event can be transmitted wirelessly, in particular to the external server via the API. These measures can be provided for all events in which shock thresholds are exceeded, in particular for events that exceed the lowest shock threshold.

Other possible measures taken in response to a shock event include placing the industrial truck in a crawl mode in which a specified maximum speed cannot be exceeded. It is also intended, alternatively or additionally, to restrict vehicle functions, such as completely preventing lifting operations or preventing the lifting of loads above a specified mass and/or above a specified height. Another possible measure is to immobilize the vehicle, in particular if the highest shock threshold is exceeded.

All the parameters mentioned, for example shock thresholds, the measures to be triggered and the related parameters such as addressees of the reports and displays when the shock thresholds are exceeded, as well as the crawl speed, can be provided and defined as target points. Accordingly, their values are configurable via the API, with the parameters preferably being stored in the vehicle and also being configurable directly there via the API. It can also be provided that a function restriction (e.g. the crawl mode) or an immobilization of the vehicle can be cancelled via the API, although generally a visual inspection of the industrial truck and thus also the unlocking directly on the vehicle is provided for this beforehand.

The aim is also achieved by a fleet management server in a logistics system, comprising an external server and at least one logistics center, wherein the logistics center comprises
a plurality of logistics handling devices which are present at a logistics site and can be operated at the logistics site, wherein both an industrial truck and a logistics device that interacts with the industrial truck are referred to as a logistics handling device;
the fleet management server; and
a plurality of access points,
wherein the fleet management server is configured to operate, via the access points, a wireless data connection with the logistics handling devices of the logistics center,
   wherein the fleet management server is further developed by the fleet management server being configured to provide a programming interface (API) and to operate a data connection with the external server via the programming interface (API) using a network protocol and, via this data connection, to transmit data relating to at least one logistics handling device of the plurality of logistics handling devices that can be operated in the logistics center.

The same or similar advantages, as already mentioned above in regard to the logistics system, apply to the fleet management server.

According to an advantageous development, the fleet management server is characterized by being configured to receive a programming interface key (API key) from the external server and to allow or deny an access of the external server to the programming interface (API), depending upon an authorization of the programming interface key.

According to a further advantageous embodiment, it is provided that the fleet management server be coupled by data technology to a plurality of end points that are data sources and be configured to transmit data of at least one end point to the external server via a parameter—specific to this end point—of the programming interface (API).

This fleet management server is, advantageously, further developed by being further configured to allow the external server to add at least one further parameter to the programming interface (API).

Furthermore, it is provided in particular that the fleet management server be configured to allow the external server to request data of at least one end point via the parameter—specific to this end point—of the programming interface (API), wherein the end point is located within a logistics handling device.

This fleet management server is, advantageously, further developed by being configured to receive data of at least one end point in the form of a push message from the logistics handling device and to forward these data as a push message to the external server via the parameter—specific to this end point—of the programming interface (API).

The push message is forwarded on the part of the fleet management server to the external server, provided that there is a corresponding authorization through a previously transmitted API key. This authorization can also optionally be configured for a specific site or for certain classes of data.

According to a further advantageous embodiment, it is provided that the fleet management server be coupled by data technology with a plurality of target points representing data sinks and be configured to receive data from the external server for at least one target point and via a parameter—specific to this target point—of the programming interface (API), and to forward said data to the at least one target point.

This fleet management server is further configured in particular to access a vehicle control system of the logistics handling device and to define parameters of the control system of the logistics handling device—in particular, of the vehicle control system of the industrial truck—as target points. In particular, the fleet management server is configured to define as target points:
an employee authorization to operate the logistics handling device—in particular, the industrial truck,
a behavior pattern of the logistics handling device—in particular, of the industrial truck—furthermore concerning in particular
a driving behavior and/or a behavior of a hydraulic system of the industrial truck,
a general operability of the logistics handling device—in particular, of the industrial truck.

The aim is further achieved by a method for operating a logistics system, wherein the logistics system comprises an external server and at least one logistics center, wherein the logistics center comprises:
a plurality of logistics handling devices present at a logistics site and operated at the logistics site, wherein not only an industrial truck, but also a logistics device that interacts with the industrial truck are referred to as a logistics handling device;
a fleet management server; and
a plurality of access points,
   wherein the fleet management server, via the access points, operates a wireless data connection with the logistics handling devices of the logistics center, and wherein this method is further developed by the fleet management server providing a programming interface (API), and the fleet management server and the external server operating via the programming interface (API) using a network protocol, and data relating to at least one logistics handling device of the plurality of logistics handling devices operated in the logistics center being transmitted via this data connection.

The same or similar advantages also apply to the method, as have already been mentioned with regard to the logistics system, for which reason repetitions shall be dispensed with.

According to an advantageous development, the method is further developed by the external server transmitting a programming interface key (API key) to the fleet management server, and the fleet management server permitting or denying access of the external server to the programming interface, depending upon an authorization of the programming interface key (API key).

According to a further advantageous embodiment, it is provided that the fleet management server be coupled by data technology to a plurality of end points that are data sources, and transmit data of at least one end point to the external server via a parameter—specific to this end point—of the programming interface (API).

This embodiment of the method is also further developed in particular by the fleet management server further allowing the external server to add at least one further parameter to the programming interface (API).

According to a further advantageous embodiment, it is provided in the method for operating the logistics system that the fleet management server further allow the external server to request data of at least one end point via the parameter—specific to this end point—of the programming interface (API), wherein, in particular, the end point is located within a logistics handling device.

Furthermore, it is provided in particular that the logistics handling device be an industrial truck and the method be further developed by at least one of the following features a) through e):

a) the industrial truck comprises a position sensor as an end point and determines its position within the logistics site,
b) the industrial truck comprises an acceleration sensor as an end point, wherein the industrial truck in particular further reads the acceleration sensor several times over a period of time and stores read acceleration values in an internal data storage location, wherein the data storage location represents an end point,
c) the industrial truck determines a current operating hours value, wherein, in particular, the operating hours value is requested from a vehicle control system of the industrial truck, and wherein the industrial truck stores the operating hours value in a data storage location, and this data storage location is an end point,
d) the industrial truck comprises a traction battery and determines a current state of charge of the traction battery or in particular requests the current state of charge from a vehicle control system of the industrial truck, wherein the industrial truck comprises a data storage location for the state of charge, stores in this data storage location information about the current state of charge, and this data storage location is an end point,
e) the industrial truck determines a current operating state—in particular, requests this from a vehicle control system of the industrial truck—wherein the industrial truck comprises a data storage location for the operating state, stores in this data storage location information about the operating state, and this data storage location is an end point.

According to a further advantageous embodiment, it is provided that the logistics handling device transmit data of least one end point in the form of a push message to the external server via the parameter—specific to this endpoint—of the programming interface (API).

This embodiment of the method is further developed in particular by the logistics handling device comprising at least one sensor—in particular, an acceleration sensor—as an end point and detecting a critical operating state by evaluating data detected by the sensor, wherein the logistics handling device also sends a push message to the external server when it has detected a critical operating state.

The method is, advantageously, further developed by the fleet management server being coupled by data technology to a plurality of target points that represent data sinks and being configured to transmit data for at least one target point via a parameter—specific to this target point—of the programming interface (API).

This embodiment of the method is further distinguished in particular by the fact that the fleet management server also accesses a control system of the logistics handling device—in particular, a vehicle control system of the industrial truck—and parameters of the control system—in particular, of the vehicle control system—are defined as target points, wherein, in particular, the following are defined as target points:
an employee authorization to operate the logistics handling device—in particular, the industrial truck,
a behavior pattern of the logistics handling device—in particular, of the industrial truck—further in particular relating to a driving behavior and/or
a behavior of a hydraulic system of the industrial truck,
a general operability of the logistics handling device—in particular, of the industrial truck.

Further features of the invention will become apparent from the description of embodiments according to the invention together with the claims and the accompanying drawings. Embodiments according to the invention can implement individual features or a combination of several features.

### BRIEF DESCRIPTION OF THE DRAWINGS

Without limiting the general inventive idea, the invention will be described below on the basis of exemplary embodiments with reference to the drawings, wherein reference is expressly made to the drawings regarding all details according to the invention which are not explained in more detail in the text. Shown are:

FIG. 1 a schematically simplified representation of a logistics system, comprising, for example, two logistics centers,

FIG. 2 a schematically simplified representation of a logistics center comprising various logistics handling devices,

FIG. 3 a schematically simplified representation of an industrial truck and a charging device as exemplary logistics handling devices which operate wireless data connections with access points,

FIGS. 4-7 exemplary schematic representations of the sequence of communication between the external server (EXT), the fleet management server (FMS), and an industrial truck (FFZ) as an exemplary logistics handling device, in each case using a programming interface (API).

In the context of the invention, features which are denoted by “in particular” or “preferably” are to be understood as optional features.

In the drawings, in each case, identical or similar elements and/or parts are provided with the same reference numbers, so that a repeated presentation is dispensed with in each case.

### DETAILED DESCRIPTION OF THE INVENTION

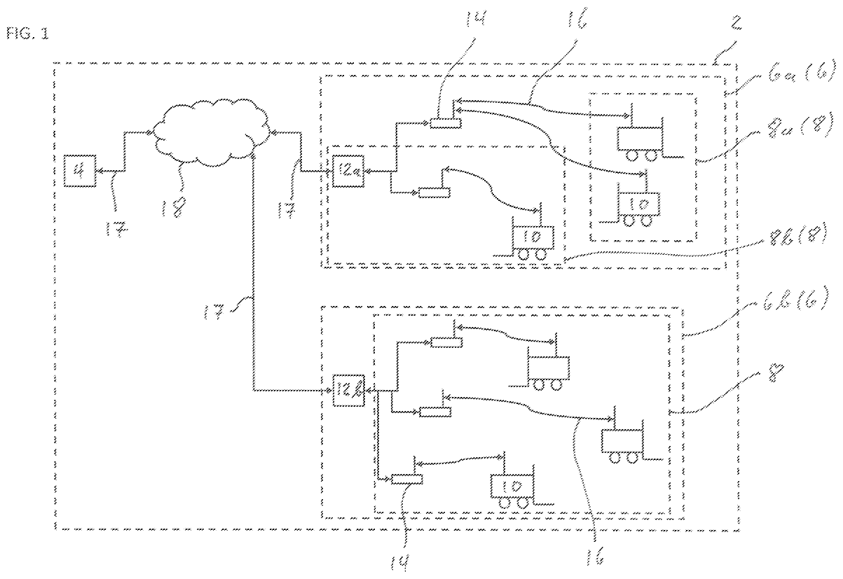

FIG. 1 is a schematic simplified representation of a logistics system 2 which comprises an external server 4 and, by way of example, a first logistics center 6a and a second logistics center 6b, which shall be designated jointly by reference number 6. Each of the logistics centers 6 comprises a plurality of industrial trucks 10 present at a logistics site 8 as exemplary logistics handling devices (9). The industrial trucks 10 can be operated at the respective logistics site 8. For reasons of clarity, only some of the industrial trucks 10 are provided with reference numbers. The first logistics center 6a comprises, by way of example, a first logistics site 8a and a second logistics site 8b, which shall be designated jointly by reference number 8. The second logistics center 6b comprises, by way of example, only one logistics site 8.

Each logistics center 6 comprises a fleet management server 12. The first logistics center 6a comprises a first fleet management server 12a, the second logistics center 6b comprises a second fleet management server 12b, and the fleet management servers are designated jointly by reference number 12. Each logistics center 6 further comprises a plurality of access points 14, which are preferably part of a respective logistics site 8. The fleet management server 12 is in each case coupled by data technology to the access points 14 via a suitable data connection 17. Data connections are indicated in FIG. 1 by double-headed arrows.

Via the access points 14, the fleet management server 12 maintains wireless data connections 16—of which, for reasons of clarity, only some are provided with reference numbers—with the industrial trucks 10. The fleet management server 12 operates in each case wireless data connections 16 with the industrial trucks 10 of its own logistics center 6, i.e., that to which the fleet management server 12 is assigned.

By way of example, in FIG. 1, the first fleet management server 12a is assigned to the first logistics site 8a and to the second logistics site 8b, which are both part of the first logistics center 6a. Accordingly, the first fleet management server 12a maintains wireless data connections 16 to the industrial trucks 10 of both the first logistics site 8a and the second logistics site 8b. By way of example, the first fleet management server 12a is located in the first logistics center 6a.

The second fleet management server 12b of the second logistics center 6b, which, by way of example, comprises only one logistics site 8, is not part of the logistics site 8. The fleet management server 12 can be arranged to be spatially separate from the logistics site 8. Provision is also made for the fleet management server 12 to be implemented, for example, in a cloud and to change its exact site, or to not define it precisely.

The fleet management server 12 is coupled by data technology to the external server 4 via one or more suitable data connections 17, which in particular include a data connection via the internet 18.

The fleet management server 12 is configured to provide a programming interface, which is also referred to below as an API. The fleet management server 12 and the external server 4 are configured to operate a data connection via the API using a network protocol. Via this data connection, data are transmitted relating to at least one logistics handling device—in the exemplary embodiment shown, at least one industrial truck 10 of the plurality of industrial trucks 10 which can be operated in the logistics center 6. The API is operated, for example, according to the open API V3 standard. Data transmission via the API takes place, for example, using HTTP as network protocol. In addition, the ISO 8601 format is used for all time stamps and date/time parameters.

It is further provided in particular that a unique site identifier (location ID) be assigned to each logistics center 6 and/or to each logistics site 8. This identifier is present in all communications packets to and from units of the relevant logistics center 6 or of the relevant logistics site 8. For example, thus in requests to the fleet management server 12 or to a logistics handling device, e.g., an industrial truck 10 of the logistics center 6 concerned. The requests can thus be assigned quickly and unambiguously to the queried end points.

Furthermore, it is provided in particular that each logistics handling device, e.g., each industrial truck 10, have a unique identifier (equipment ID). This globally unique identifier can be assigned to an internal number (equipment no.). An assignment between an internal number (equipment no.) and the unique identifier of the logistics handling device, e.g., of the industrial truck 10 (equipment ID), can be flexibly adapted and changed. This may be necessary if, for example, industrial trucks 10 are removed from a logistics site 8 and added to another logistics site 8. The same applies to the addition and removal of industrial trucks 10 at only one logistics site 8 or logistics center 6—for example, in the case of rental vehicles.

Via the site identifier (location ID), information about the relevant logistics center 6 or the relevant logistics site 8 can be retrieved, e.g., a number of logistics handling devices—in particular, industrial trucks 10—which are being operated in the relevant logistics center 6 or at the relevant logistics site 8. Further site-specific information would, for example, be a total of all operating hours of all industrial trucks 10 performed in a certain period of time, disturbances occurring during a certain period of time, or the like. Such information relating to the operation of the industrial trucks 10 in the corresponding logistics center 6 can be or is stored in the fleet management server 12, which is assigned to the logistics center 6.

The data storage location, e.g., a non-volatile data storage medium or the like, is a data storage resource of the fleet management server 12. These data storage resources do not have to be kept locally in the fleet management server 12 itself—for example, if the fleet management server 12 is implemented as a virtual machine in a cloud. Such a decentralized resource and a decentralized server are also regarded as part of the logistics center 6. Only the functional assignment is decisive, not the spatial arrangement.

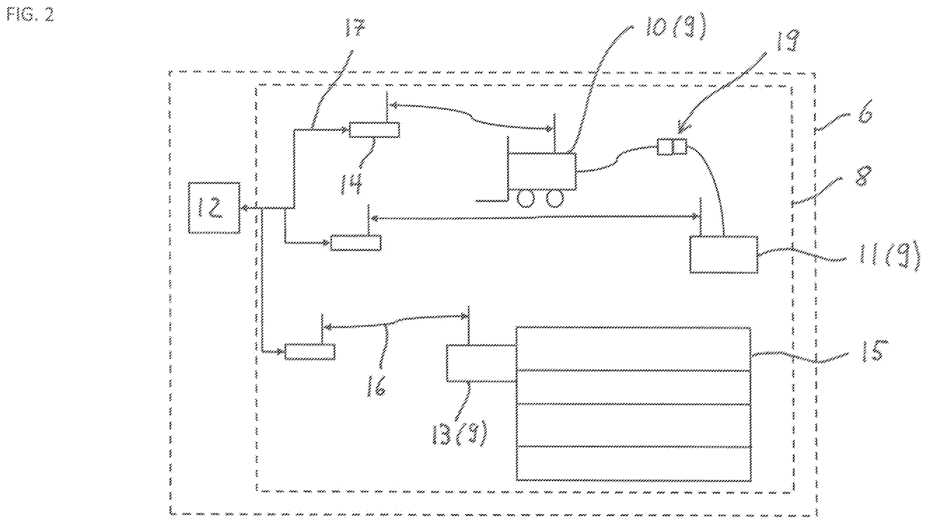

FIG. 2 is a schematic simplified representation of a further logistics center 6 which, by way of example, comprises a single logistics site 8. In the logistics site 8 shown by way of example, a fleet management server 12 is operated, which is also an exemplary part of the logistics center 6, but not part of the logistics site 8. The fleet management server 12 is coupled by data technology to access points 14 via data connections 17, of which, for reasons of clarity, only one is provided with a reference number. The access points 14 are connected with various logistics handling devices 9 via wireless data connections 16, of which, for reasons of clarity, only one is provided with a reference number. By way of example, the logistics handling devices 9 are an industrial truck 10, a charging device 11 for charging a traction battery of the industrial truck 10, and a storage and retrieval machine 13 for serving a high bay 15. The industrial truck 10 is designed to move logistics units into this bay 15 or remove them therefrom. In this sense, the industrial truck 10 interacts with the high bay 15, and thus also with the storage and retrieval machine 13. The charging device 11 is configured to charge the traction battery of the industrial truck 10. For this purpose, the charging device 11 is coupled to the industrial truck 10 via a plug connection 19, and in this way interacts with the industrial truck 10.

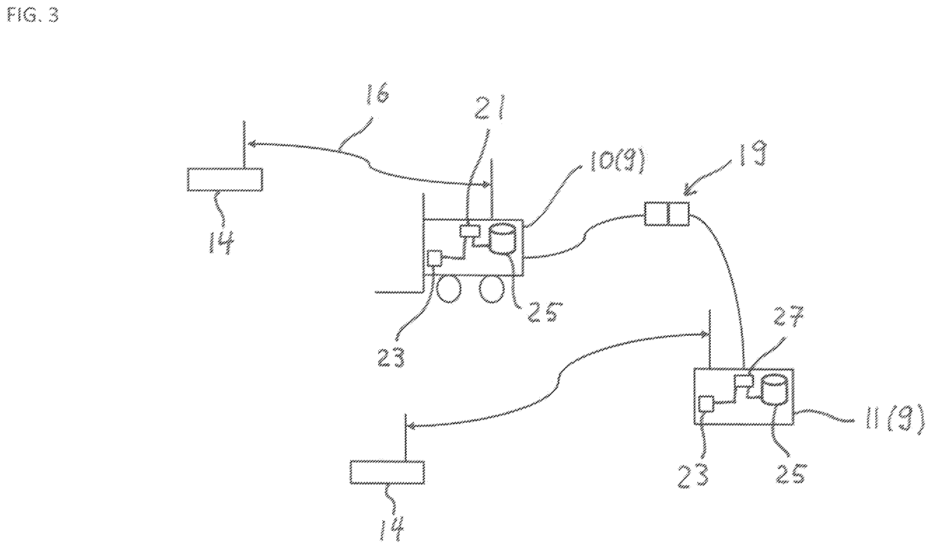

FIG. 3 shows, in a schematically simplified view, an industrial truck 10 and a charging device 11 which are coupled to one another via the plug connection 19. Both the industrial truck 10 and the charging device 11 are in each case connected by data technology to one of the access points 14 via a wireless data connection 16.

The industrial truck 10 comprises a vehicle control unit 21, which is connected to a sensor 23—for example, an acceleration sensor. In addition, the vehicle control system 21 is connected to a data memory 25. According to further exemplary embodiments, both the sensor 23 and the data memory 25 can be designed as part of the vehicle control system 21.

The charging device 11 comprises a control system 27, which is likewise connected to a sensor 23—for example, a temperature sensor or a voltage sensor. The control system 27 of the charging device 11 is also connected to a data memory 25. As already mentioned in connection with the industrial truck 10, the sensor 23, shown as part of the charging device 11, and the memory 25 can also be designed as part of the control system 27.

The sensors 23 mentioned, as well as the data memories 25 mentioned or storage regions of these data memories 25, represent end points within the logistics system 2. The data memory 25 can act both as a data source and as a data sink. However, the sensor 23 represents a data source exclusively.

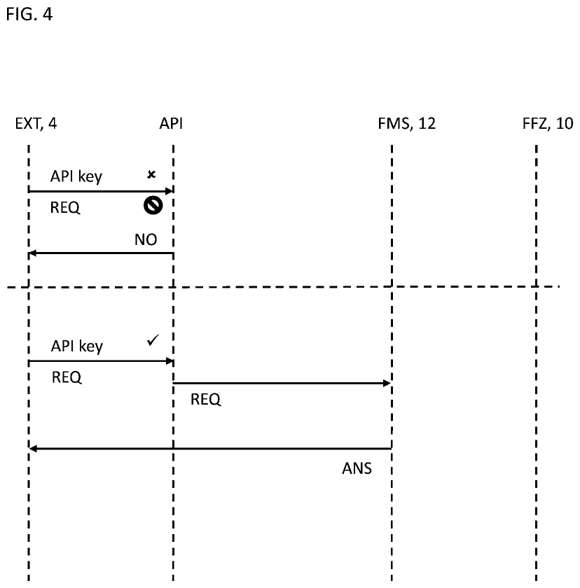

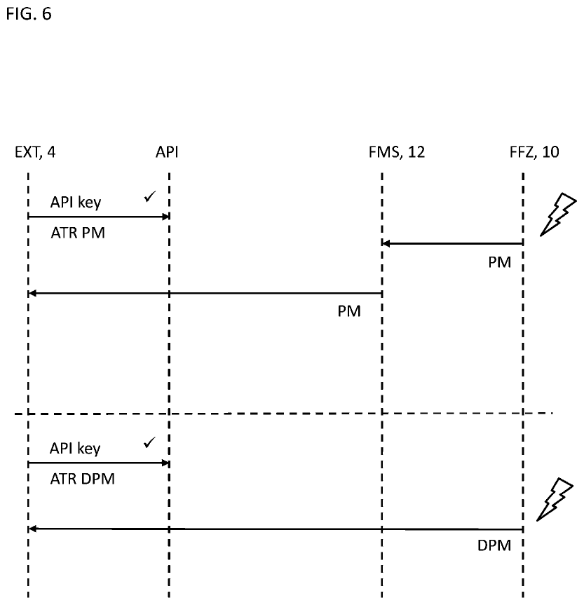

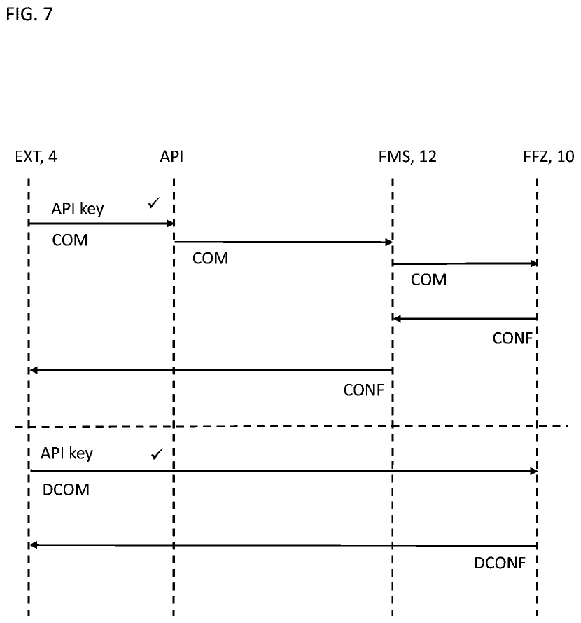

FIGS. 4 through 6 in each case show, by way of example, a schematic representation of the sequence of communication between the external server 4 (also referred to as EXT), the fleet management server 12 (also referred to as FMS), and an industrial truck 10 (also referred to as FFZ) as an exemplary logistics handling device 9. In the context of the present description, reference is made merely by way of example to an industrial truck 10 as a logistics handling device 9. In the same or similar manner as the functionality is described with regard to the industrial truck 10, this also applies to other logistics handling devices 9 of the logistics system 2 according to the invention.

Communication between the external server 4 and the fleet management server 12 takes place via a programming interface (also referred to below as API). Communication between the external server 4 and an industrial truck 10 (also referred to as FFZ) is also shown.

The upper part of FIG. 2 shows that the external server 4 sends a program interface key (also referred to as API key) to the API provided by the fleet management server 12. The fleet management server 12 is configured to allow or deny access of the external server 4 to the API, depending upon an authorization of the API key. In the example shown in FIG. 2, the API key is sent together with a request REQ. In the upper part of FIG. 2, it is shown by way of example that the API key sent does not authorize making the request REQ. Accordingly, the fleet management server responds via the API to the request REQ with a rejection NO. In the lower part of FIG. 2, it is shown that the API key is authorized to make the request REQ; the request REQ is accordingly forwarded via the API to the fleet management server 12. This responds with an answer ANS. The answer ANS includes, for example, data relating to the use of the industrial trucks 10 being operated in the logistics center 6 to which the fleet management server 12 is assigned.

The fleet management server 12 is coupled by data technology to a plurality of end points that are data sources. Data sources are, for example, non-volatile data memories or data storage areas which are present in the fleet management server 12, or also non-volatile data memories or data storage areas which are present in an industrial truck 10 with which the fleet management server 12 is coupled by data technology via the wireless data connections 16. End points that are data sources can also be sensors within an industrial truck 10—for example, a position sensor, an acceleration sensor, a temperature sensor, or the like. If the end point is a position sensor and if the industrial truck 10 is configured to determine its position within the logistics site 8, the external server 4 will be able to directly request the position of the industrial truck 10 via the API, provided the transmitted API key authorizes it to do so. If the end point is an acceleration sensor of the industrial truck 10, the external server 4 will be able to request current acceleration values of the industrial truck 10 in the same way. However, the industrial truck 10 can also be configured to read the acceleration sensor several times during a certain period of time, e.g., during a shift, and to store the read-out acceleration values on an internal data storage location or to transmit them to the fleet management server 12. This data storage location, too, can be defined as an end point. In such a case, the external server 4 will be able to retrieve and evaluate the acceleration values recorded by the industrial truck 10, depending upon the authorization of the transmitted API key. These values provide information about the type of load and use of the industrial truck 10, for example. The industrial truck 10 can further be configured to record an operating hours value, which is typically stored in the vehicle control system of the industrial truck 10. This data storage location also can be defined as an end point, so that, depending upon the authorization of the API key transmitted by the external server 4, it will be capable of directly requesting the operating hours value from the vehicle control system of the industrial truck 10 via the API.

Requesting these data determined by the end points or present at the end points is effected via a parameter—specific to the end point—of the API. For example, a parameter regarding the number of operating hours or the position of an industrial truck 10 can be defined in the API.

The fleet management server 12 can further be configured such that, depending upon the authorization of the transmitted API key, the fleet management server 12 allows the external server 4 to add further parameters to the API. For example, a parameter relating to the user of an industrial truck 10 could be added to the API if such a parameter is of interest to the operator of the external server 4.

The communication described above is illustrated schematically in FIG. 3. In the upper part of FIG. 3, it is shown that the external server 4 sends an API key to the API of the fleet management server 12 together with a request REQ. If the API key authorizes making the request REQ, this can be confirmed positively by the fleet management server 12 (cf. ANS in FIG. 2, lower); in any case, the request REQ reaches the fleet management server 12. Depending upon the authorization of the API key—and this is supposed to be present by way of example—the request REQ is then forwarded by the fleet management server 12 to the industrial truck 10 or to a specific industrial truck 10. This provides a response ANS, e.g., a value of the number of operating hours read from the operations control system, and supplies this value to the fleet management server 12. This communicates the answer ANS to the external server 4 via the API.

Another possibility for communication between the external server 4 and the industrial truck is a direct request DREQ of the external server 4 to the industrial truck 10 via the API. In such a case, the fleet management server 12 forwards the direct request DREQ, after checking the authorization of the API key for making such a request, directly to the industrial truck 10. The industrial truck 10 responds in the reverse direction via the API with a direct response DANS to the external server 4.

According to further exemplary embodiments, the request lands at the API gateway of the fleet management server 12 and is forwarded from there to, for example, the industrial truck 10. Such a form of communication has a slightly greater time delay than the above-described direct request DREQ.

According to a further exemplary embodiment, the industrial truck 10 is configured to transmit data of at least one end point in the form of a push message to the external server 4 via the parameter—specific to this end point—of the API. This situation is illustrated in FIG. 4. First, the external server 4 identifies itself to the API of the fleet management server 12 using a corresponding API key. It sends the API key, for example, together with a message ATR PM in which it signals that it is generally available for receiving push messages PM of the industrial truck 10. After successful verification of the associated API key, indicated by a checkmark, the external server 4 is ready to receive push messages PM. If an event, indicated by an arrow, occurs at the industrial truck 10, a push message PM will be generated in the industrial truck 10. Such an event is, for example, a value for acceleration that is read at an acceleration sensor of the industrial truck 10 and which exceeds a prespecified limit value, and thus indicates a critical operating state of the industrial truck 10. Such a situation occurs, for example, when an industrial truck 10 collides with an object.

The industrial truck 10 generates a push message PM, which is forwarded by the fleet management server 12 to the external server 4 via the API. A user of the external server 4 is enabled to respond directly to the critical state of the industrial truck 10—for example, in order to initiate repair or countermeasures.

Another scenario is shown in the lower part of FIG. 4. There, the industrial truck 10 transmits a direct push message DPM to the external server 4 in response to an event, shown by an arrow. The fleet management server 12 only forwards this message, without processing it. This assumes that, with a corresponding API key, the external server 4 has previously authenticated to the API of the fleet management server 12 the reception of direct push messages DPM. Such an authentication is carried out, for example, by the external server 4 sending a message ATR DPM to the API which includes the associated API key.

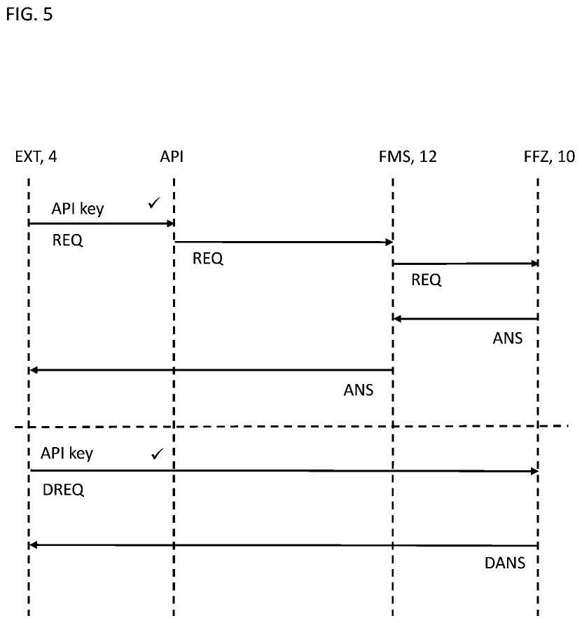

According to a further exemplary embodiment, the logistics system 2 is configured such that the external server 4 is enabled to carry out a configuration of the industrial truck 10 directly via the API. For this purpose, the fleet management server 12 is coupled by data technology to a plurality of target points that represent data sinks. Such target points are, for example, data storage regions in the operations control system of the industrial truck 10, e.g., regarding an employee authorization to operate the industrial truck 10 or data regarding a behavior pattern of the industrial truck 10—for example, regarding its driving behavior or even a behavior of the hydraulic system of the industrial truck. A further target point can be a data storage area in the vehicle control system of the industrial truck 10 which relates to a general operability of the industrial truck 10. In other words, the external server 4 is allowed to restrict or even completely switch off the operability of an industrial truck by accessing this target point. Data that are determined for at least one such target point are transmitted via a parameter—specific to this target point—of the API. This is illustrated in FIG. 5.

The external server 4 sends a command COM and the associated API key to the API of the fleet management server 12. If the authorization of the API key is suitable for allowing the external server to send the command COM to the industrial truck 10, the COM command will proceed to the fleet management server 12 and, from there, onwards to the industrial truck 10. The industrial truck 10 confirms the reception of the command COM by means of a command confirmation CONF. This is communicated back to the external server 4 via the fleet management server 12.

In the lower part of FIG. 5 it is shown that, in such a scenario, a direct communication between the external server 4 and the industrial truck 10 can also be provided. On the basis of the transmitted API key, the fleet management server 12 checks only the authorization for such a type of communication. A direct command DCOM is sent together with the associated API key via the API to the industrial truck 10, wherein the fleet management server 12 checks only the authorization of the API key on the API and forwards the direct command DCOM to the industrial truck. The industrial truck 10 responds to the direct command DCOM with a direct command confirmation DCONF, which is communicated to the external server 4 in the opposite direction via API.

All of the features mentioned, also the features to be taken from the drawings alone and also individual features disclosed in combination with other features, are considered to be essential to the invention, separately and in combination. Embodiments according to the invention can be fulfilled by individual features or by a combination of several features.

### LIST OF REFERENCE NUMBERS

2 Logistics system
4 External server
6 Logistics center
6a First logistics center
6b Second logistics center
8 Logistics site
8a First logistics site
8b Second logistics site
9 Logistics handling device
10 Industrial truck
11 Charging device
12 Fleet management server
12a First fleet management server
12b Second fleet management server
13 Storage and retrieval machine
14 Access point
15 High bay
16 Wireless data connection
17 Data connection
18 Internet
19 Plug connection
21 Vehicle control system
23 Sensor
25 Data memory
27 Control system
API Programming interface
API key Programming interface key
REQ Request
NO Rejection
ANS Answer
DREQ Direct request
DANS Direct answer
ATR PM Message
PM Push message
ATR DPM Message
DPM Direct push message
COM Command
CONF Command confirmation
DCOM Direct command
DCONF Direct command confirmation
EXT External server
FMS Fleet management server
FFZ Industrial truck

1. A logistics system comprising:
an external server;
at least one logistics center that comprises a plurality of logistics handling devices which are present at a logistics site and are operable in the logistics site, wherein at least a first one of the plurality of logistics handling devices is an industrial truck and at least a second one of the plurality of logistics devices is a logistics device that interacts with the industrial truck;
a fleet management server; and
a plurality of access points;
wherein the fleet management server is configured to operate, via the plurality of access points, a wireless data connection with the plurality of logistics handling devices of the logistics center,
wherein the fleet management server is configured to provide a programming interface, and
wherein the fleet management server and the external server are configured to operate a data connection via the programming interface using a network protocol, and, via this data connection, to transmit data relating to at least one of the plurality of logistics handling devices that are operable in the logistics center.

2. The logistics system according to claim 1, wherein the external server is configured to transmit a program interface key to the fleet management server, and wherein the fleet management server is configured to allow or deny access of the external server to the programming interface, depending upon an authorization of the program interface key.

3. The logistics system according to claim 1, wherein the fleet management server is coupled by data technology to a plurality of end points that are data sources, and wherein the fleet management server is configured to transmit data of at least one end point to the external server via a parameter of the programming interface, which is specific to the at least one end point.

4. The logistics system according to claim 3, wherein the fleet management server is further configured to allow the external server to add at least one further parameter to the programming interface.

5. The logistics system according to claim 3, wherein the fleet management server is further configured to allow the external server to request data of at least one end point via the parameter of the programming interface, which is specific to the at least one end point, and wherein the at least one end point is located within one of the plurality of logistics handling devices.

6. The logistics system according to claim 3, wherein the first one of the plurality of logistics handling devices has at least one of the following features a) through e):
a) the industrial truck comprises a position sensor as an end point and is configured to determine its position within the logistics site,
b) the industrial truck comprises an acceleration sensor as an end point, wherein the industrial truck is configured to read the acceleration sensor several times during a period of time and to store read acceleration values in an internal data storage location, and wherein the data storage location represents an end point,
c) the industrial truck is configured to determine a current operating hours value based on a request from a vehicle control system of the industrial truck, and wherein the industrial truck comprises a data storage location for the operating hours value, and this data storage location is an end point,
d) the industrial truck comprises a traction battery and is configured to determine a current state of charge of the traction battery based on a request from a vehicle control system of the industrial truck, and wherein the industrial truck comprises a data storage location for the state of charge, and this data storage location is an end point,
e) the industrial truck is designed to determine a current operating state based on a request from a vehicle control system of the industrial truck, and wherein the industrial truck comprises a data storage location for the operating state, and this data storage location is an end point.

7. The logistics system according to claim 1, wherein at least one of the plurality of logistics handling devices is configured to transmit data of at least one end point in the form of a push message to the external server via the parameter of the programming interface, which is specific to the at least on end point.

8. The logistics system according to claim 7, wherein the at least one of the plurality of logistics handling devices comprises at least one acceleration sensor as an end point and is configured to detect a critical operating state by evaluating data captured by the acceleration sensor, and wherein the at least one of the plurality of logistics handling devices is further configured to send a push message to the external server when a critical operating state is detected.

9. The logistics system according to claim 1, wherein the fleet management server is coupled by data technology to a plurality of target points that represent data sinks and is configured to transmit data for at least one of the plurality of target points to the programming interface via a parameter specific to the at least one of the plurality of target points.

10. The logistics system according to claim 9, wherein the fleet management server is further configured to access a vehicle control system of the first one of the plurality of logistics handling devices, and to define parameters of the vehicle control system as target points, and wherein the fleet management server is configured to define as target points:
an employee authorization to operate the first one of the plurality of logistics handling devices, a behavioral pattern of the first one of the plurality of logistics handling relating to a driving behavior and/or a behavior of a hydraulic system of the industrial truck,
a general operability of the first one of the plurality of logistics handling devices.

11. A fleet management server in a logistics system that includes an external server, at least one logistics center that comprises a plurality of logistics handling devices which are present at a logistics site and are operable in the logistics site, wherein at least a first one of the plurality of logistics handling devices is an industrial truck and at least a second one of the plurality of logistics devices is a logistic device that interacts with the industrial truck, and a plurality of access points (14),
wherein the fleet management server is configured to operate, via the plurality of access points (14), a wireless data connection with the plurality of logistics handling devices of the logistics center, and wherein the fleet management server is configured to provide a programming interface, and
wherein the fleet management server is configured to operate a data connection with the external server via the programming interface using a network protocol and, via this data connection, to transmit data relating to at least one of the plurality of logistics handling devices that are operable in the logistics center.

12. The fleet management server according to claim 11, wherein the fleet management server is configured to receive a program interface key from the external server and to allow or deny access of the external server to the programming interface, depending upon an authorization of the program interface key.

13. The fleet management server according to claim 11, wherein the fleet management server is coupled by data technology to a plurality of end points that are data sources and is configured to transmit data of at least one end point to the external server via a parameter of the programming interface, which is specific to the at least one end point.

14. The fleet management server according to claim 13, wherein the fleet management server is further configured to allow the external server to add at least one further parameter to the programming interface.

15. The fleet management server according to claim 13, wherein the fleet management server is further configured to allow the external server to request data of at least one end point via the parameter of the programming interface, which is specific to the at least one end point, and wherein the at least one end point is located within one of the plurality of logistics handling devices.

16. The fleet management server according to claim 15, wherein the fleet management server is configured to receive data of at least one end point in the form of a push message from at least one of the logistics handling devices and to forward these data to the external server as a push message via the parameter of the programming interface, which is specific to the at least one of the logistics handling devices.

17. The fleet management server according to claim 11, wherein the fleet management server is coupled by data technology to a plurality of target points that represent data sinks and is configured to receive data for at least one of the plurality of target points from the external server via a parameter of the programming interface, which is specific to the at least one of the plurality of target points, and to forward the data to the at least one of the plurality of target points.

18. A method for operating a logistics system that includes:
an external server;
at least one logistics center that includes a plurality of logistics handling devices which are present at a logistics site and are operated at the logistics site, wherein at least a first one of the plurality of logistics handling devices is an industrial truck and at least a second one of the plurality of logistics devices is a logistics device that interacts with the industrial truck;
a fleet management server; and
a plurality of access points (14);
wherein the method comprises operating the fleet management server, via the access points and a wireless data connection with the plurality of logistics handling devices of the logistics center such that the fleet management server provides a programming interface, and the fleet management server and the external server operate a data connection via the programming interface using a network protocol, and, such that via this data connection, data are transmitted relating to at least one of the plurality of logistics handling devices operated in the logistics center.

19. The method according to claim 18, wherein the external server transmits a program interface key to the fleet management server, and the fleet management server allows or denies access of the external server to the programming interface, depending upon an authorization of the programming interface key.

20. The method according to claim 18, wherein the fleet management server is coupled by data technology to a plurality of end points that are data sources and transmits data of at least one of the plurality of end points to the external server via a parameter of the programming interface, which is specific to the at least one of the plurality of end points.

21. The method according to claim 20, wherein the fleet management server is configured to further allow the external server to add at least one further parameter to the programming interface.

22. The method according to claim 20, wherein the fleet management server is configured to further allow the external server to request data of at least one of the plurality of end points via the parameter of the programming interface, which is specific to the at least one of the plurality of end points, and wherein the end point is located within one of the plurality of logistics handling devices.

23. The method according to claim 20, wherein the first one of the plurality of logistics handling devices has at least one of the following features a) through e):
a) the industrial truck comprises a position sensor as an end point and determines its position within the logistics site,
b) the industrial truck comprises an acceleration sensor as an end point, wherein the industrial truck reads the acceleration sensor several times over a period of time and stores read acceleration values in an internal data storage location, wherein the data storage location represents an end point,
c) the industrial truck determines a current operating hours value, wherein the operating hours value is requested from a vehicle control system of the industrial truck, and wherein the industrial truck stores the operating hours value in a data storage location, and this data storage location is an end point,
d) the industrial truck comprises a traction battery and determines a current state of charge of the traction battery or requests the current state of charge from a vehicle control system of the industrial truck, and wherein the industrial truck comprises a data storage location for the state of charge, stores information on the current state of charge in this data storage location, and this data storage location is an end point,
e) the industrial truck determines a current operating state or requests the current operating state from a vehicle control system of the industrial truck, and wherein the industrial truck comprises a data storage location for the operating state, stores information about the operating state in this data storage location, and this data storage location is an end point.

24. The method according to claim 20, wherein at least one of the plurality of logistics handling devices transmits to the external server data of at least one of the plurality of end points in the form of a push message via the parameter of the programming interface, which is specific to the at least one of the plurality of end points.

25. The method according to claim 24, wherein the first one of the plurality of logistics handling devices comprises at least one acceleration sensor as an end point and, by evaluating data detected by the acceleration sensor, detects a critical operating state, wherein the first one of the plurality of logistics handling devices further sends a push message to the external server if it has detected a critical operating state.

26. The method according to claim 19, wherein the fleet management server is coupled by data technology to a plurality of target points representing data sinks and transmits data for at least one of the plurality of target points to the programming interface via a parameter specific to the at least one of the plurality target points.

27. The method according to claim 26, wherein the fleet management server also accesses a vehicle control system of the first one of the plurality of logistics handling devices and wherein one or more of the following parameters of the vehicle control system are defined as target points:
an employee authorization to operate the first one of the plurality of logistics handling devices,
a behavior pattern of the first one of the plurality of logistics handling devices relating to a driving behavior and/or a behavior of a hydraulic system of the industrial truck, and
a general operability of the first one of the plurality of logistics handling devices.
